(19) United States
(12) Patent Application Publication
(10) Pub. No.: US 2018/0201085 A1
(43) Pub. Date: Jul. 19, 2018

(54) DRIVABLE TWIST-BEAM REAR AXLE HAVING A TRANSVERSE PROFILED ELEMENT AND LONGITUDINAL CONTROL ARMS CONNECTED TO THE TRANSVERSE PROFILED ELEMENT AT THE ENDS THEREOF

(71) Applicant: ZF Friedrichshafen AG, Friedrichshafen (DE)

(72) Inventors: Josef HOLTHEIDE, Neuenkirchen (DE); Alfons NORDLOH, Visbek (DE); Markus WULF, Hille (DE); Michael BEYER, Porta Westfalica (DE); Felix KALLASS, Osnabrück (DE)

(21) Appl. No.: 15/744,098

(22) PCT Filed: Jun. 13, 2016
(86) PCT No.: PCT/EP2016/063424

§ 371 Date: Jan. 12, 2018

(30) Foreign Application Priority Data
Jul. 16, 2015 (DE) 10 2015 213 357.5

(51) Int. Cl. B60G 21/05; B60G 7/02; B60G 7/00; B60K 7/00

(52) U.S. Cl. CPC B60G 21/052; B60G 7/02; B60G 7/008; B60G 7/001; B60K 7/0007; B60G 2200/21; B60K 2007/0038; B60G 2204/147; B60G 2204/182; B60G 2204/148; B60G 2206/10; B60G 2300/50; B60G 2202/136

(57) ABSTRACT

A drivable torsion beam axle (2) with a transverse profiled element and trailing arms (1) connected, at each end, to the profiled element is described, within which, at least in some areas, a drive-train (7) is arranged in each case and by which the torsion beam axle (2) can be connected to a vehicle body. The trailing arms (1) are, in each case, made as two-component housing castings with a housing plane of division extending in the longitudinal direction.

The application is a National Stage completion of PCT/EP20161/063424 filed Jun. 13, 2016, which claims priority from German patent application serial no. 10 2015 213 357.5 filed Jul. 16, 2015.

### FIELD OF THE INVENTION

The invention concerns a drivable torsion beam axle with a transverse profiled element and respective trailing arms connected to the ends of the transverse profiled element.

### BACKGROUND OF THE INVENTION

From DE 10 2011 080 037 A1 a vehicle axle for a motor vehicle or a torsion beam axle for an electric vehicle is known. The vehicle axle comprises at least one trailing arm, on which a drive unit close to the wheel, having an electric machine and a transmission unit, is arranged. The drive unit close to the wheel is at least partially in the form of a trailing arm. In an embodiment of the vehicle axle, the drive unit comprises a housing made of at least two components, with a housing half on the wheel side and a housing half on the trailing arm side.

DE 10 2011 005 625 A1 discloses a drive device for driving a wheel of a torsion beam axle of an electrically driven vehicle. The drive device comprises an electric machine and a transmission connected into the force flow, which transmission, as viewed in the force flow direction during traction operation, is on the drive output side of the electric machine. The housing of the electric machine or the housing of the transmission are bolted directly to the trailing arm of the vehicle axle or integrated in the trailing arm in the form of a multi-component welded assembly. In addition, it is also possible for the housing of the electric machine or the housing of the transmission to be made integrally as one piece with the trailing arm, and the electric machine and the transmission can have a common housing.

DE 10 2011 080 236 A1 describes a drive device for a single wheel of a motor vehicle, which comprises an electric driving means with at least one drive input shaft for the wheel and a transmission. The transmission co-operates with the at least one drive input shaft to transmit torque to the drive input of the wheel. In a housing of the electric driving means or electric motor are arranged the electric motor itself, an energy storage device, the drive input shaft, a locking device and a transmission in the form of a planetary gearset. A pinion spur gear arrangement, an output shaft and part of a connecting shaft and a wheel bearing are arranged in a housing on the wheel side, which is connected to the housing of the electric motor. In addition, in the area of the wheel are arranged in an already known manner a wheel carrier and a brake. During driving operation of a motor vehicle the brake serves as a service brake for braking the vehicle. Overall, at least part of the housing of the electric motor and the transmission are made as a trailing arm of the torsion beam axle, which is arranged and able to rotate on the vehicle by means of torsion beam bearings.

DE 10 2011 082 390 A1 describes a method for producing a trailing arm of a torsion beam axle, into which a drive unit of a wheel-associated electric drive comprising an electric machine and a transmission is integrated. In this method, the trailing arm is made as a casting with a box profile, such that the contours for obtaining the area for accommodating the transmission, the connection point to the vehicle body, the bore for receiving the transverse section that connects the two trailing arms of the torsion beam axle to one another, the U-section of the trailing arm, the box profile and the area for accommodating the electric machine are produced by means of cores. Further contours for obtaining the connection point of the trailing arm to the vehicle body, the bore for receiving the transverse section and the U-section of the trailing arm are produced by means of a common core.

However, trailing arms produced by the above-described method are characterized by high production costs since the cores are lost. Furthermore, with all torsion beam axles made until now and known from the prior art, for maintenance and servicing work, the entire trailing arm has to be dismantled bit by bit until all the components of the drive-trains of the torsion beam axles that comprise the electric machines and transmissions are accessible.

### SUMMARY OF THE INVENTION

Accordingly, the purpose of the present invention is to make available a drivable torsion beam axle characterized by low production costs and little maintenance effort.

According to the invention, this objective is achieved with a drivable torsion beam axle having the characteristics specified in the claims.

In the drivable torsion beam axle according to the invention, which is made with a transverse profiled element and respective trailing arms connected to the ends of the profiled element, within the trailing arms there is arranged in each case, at least in some areas, a drive-train. Furthermore, by way of the trailing arms, the torsion beam axle can be connected to a vehicle body.

According to the invention, the trailing arms are each made as a two-part housing casting with a longitudinally extending housing plane of division, so that the two halves of the housing of the trailing arm can advantageously be made in a simply shaped manner and can therefore be produced better and more inexpensively.

Once the component as a whole has been opened up, then compared with systems known from the prior art the components of the drive-train located inside the trailing arm housing are more easily accessible for maintenance or servicing, since during maintenance one housing half of a trailing arm can be taken completely off the second housing half of the trailing arm.

Furthermore, compared with torsion beam axles known from the prior art the drivable torsion beam axle according to the present invention demands less sealing effort and complexity in the area of the trailing arms, since sealing only need be provided in the contact area between the two housing castings of the trailing arms, whereas known systems made with a plurality of housing covers have many more parting joints to be sealed.

Moreover, if the two housing castings are made from the same material, their thermal behavior and also their behavior when loads are applied will be the same.

In advantageous embodiments of the drivable torsion beam axle according to the invention, the trailing arms in their installed condition have an upper housing component and a lower housing component, or, in their installed condition, a housing component on the wheel side and a housing component of the trailing arm that faces away from the wheel, so that depending on the application concerned, by virtue of one large component joint in the longitudinal direction of the trailing arm there will be a left and a right, or an upper and a lower housing half, whose design can be produced more simply than those of the systems known from the prior art, so that the trailing arms can be made in a better and more inexpensive way.

If the trailing arms have two planes of division that enclose an obtuse angle with one another, then the torsion beam axle can be adapted to various vehicle systems with little effort.

In the embodiment of the drivable torsion beam axle that can also be adapted to existing vehicle systems with little effort, the planes of division intersect in the area of a mid-point of a wheel axle or a shaft of the drive-train.

In a simple and inexpensively produced further development of the drivable torsion beam axle according to the invention, the housing halves form, in each case, at least part of a seat for a bearing device by means of which the torsion beam axle can be brought into functional connection with a vehicle body. In this way, during the casting process for producing the seat for a bearing device, no core that would increase the production costs has to be provided, which as a so-termed lost core could not be used for a subsequent casting process.

If the housing halves each form part of a seat for the transverse profiled element, the drivable torsion beam axle according to the invention can again be made in a simple and inexpensive manner without lost cores.

In an embodiment of the drivable torsion beam axle according to the invention that is simply designed and can be assembled with little effort, the transverse profiled element has end areas with a polygonal shape at least on the outside, in which corresponding polygonal shaped seats for the trailing arms are arranged in an interlocking manner and are connected at least rotationally fixed to the trailing arms.

If the transverse profiled element is in contact at flange areas at it ends against corresponding flange-like areas of the seats of the trailing arms, the transverse profiled element can be connected by bolts to the trailing arms in a simple manner.

If inside spaces delimited by the housing halves of the trailing arms, provided at least in part for accommodating the drive-trains, are delimited on a wheel side of the trailing arms and/or on a side of the trailing arms facing away from the wheels, in each case by cover elements connected detachably to the housing halves, then assembly and, when necessary, maintenance of the drivable torsion beam axle according to the invention are further simplified when required.

In a simply designed embodiment of the drivable torsion beam axle according to the invention that can be operated with little effort, the drive-train comprises at least one electric machine.

In an embodiment of the drivable torsion beam axle according to the invention that takes up little installation space, the drive-train comprises a transmission device associated with the electric machine and arranged between an output shaft of the electric machine and a wheel axle, in the area of which torque delivered by the electric machine can be converted to the desired extent.

If the output shaft and the wheel axle are arranged to extend parallel to one another and, in the installed condition, are a distance apart at least in the longitudinal direction of the vehicle, the drivable torsion beam axle according to the invention can be adapted with little effort to available installation spaces present in various vehicle designs.

In an embodiment of the drivable torsion beam axle according to the invention that can be assembled and dismantled simply, the housing components are connected to one another by a plurality of bolt joints arranged around the periphery of the housing components.

In an easy-to-assemble embodiment of the drivable torsion beam axle according to the invention, the housing components are connected to one another by way of a centering device by means of which, before the final connection between the two housing components is made, the two housing components of the trailing arm can be brought to the desired position relative to one another and held there without further measures.

In an embodiment of the drivable torsion beam axle according to the invention that can be installed in a vehicle with little effort, the trailing arms are functionally connected with a wheel carrier on their wheel side.

If a spring and/or damper seat is made integrally with one of the housing components of the trailing arms, the assembly of the torsion beam axle is simplified.

The connection between the transverse profiled element made as a torsion section and the trailing arms of the drivable torsion beam axle can be formed for example by means of a press fit, a bolted joint or a materially bonded connection. Depending on the type of connection chosen, advantages, such as the avoidance of heat-affected zones, adjustability and detachability, and inexpensive production counteract disadvantages such as non-detachability of the connection, a welded flange for bolting, and changes of the material properties due to the heat input.

Both the characteristics indicated in the claims and those indicated in the following example embodiments of the drivable torsion beam axle according to the invention are in each case suitable as further developments of the object of the invention, whether taken in isolation or in any desired combination with one another.

### BRIEF DESCRIPTION OF THE DRAWINGS

Further advantages and advantageous further developments of the invention emerge from the claims and the example embodiments whose principle is described with reference to the drawing. For the sake of clarity, in the description of the various example embodiments the same indexes are used for structurally and functionally equivalent components. The drawings show:

FIG. 1: A trailing arm of a first embodiment of the drivable torsion beam axle according to the invention, with a drive-train shown in an exploded view;

FIG. 2: The trailing arm of FIG. 1, shown in a view characterized in more detail in FIG. 1;

FIG. 3: The trailing arm of FIG. 1 viewed from above;

FIG. 4: A trailing arm of a second embodiment of the drivable torsion beam axle according to the invention, shown in an exploded view;

FIG. 5: The trailing arm of FIG. 4, viewed from above; and

FIG. 6: A trailing arm of a third embodiment of the drivable torsion beam axle according to the invention, shown in an exploded view.

### DETAILED DESCRIPTION OF THE PREFERRED EMBODIMENTS

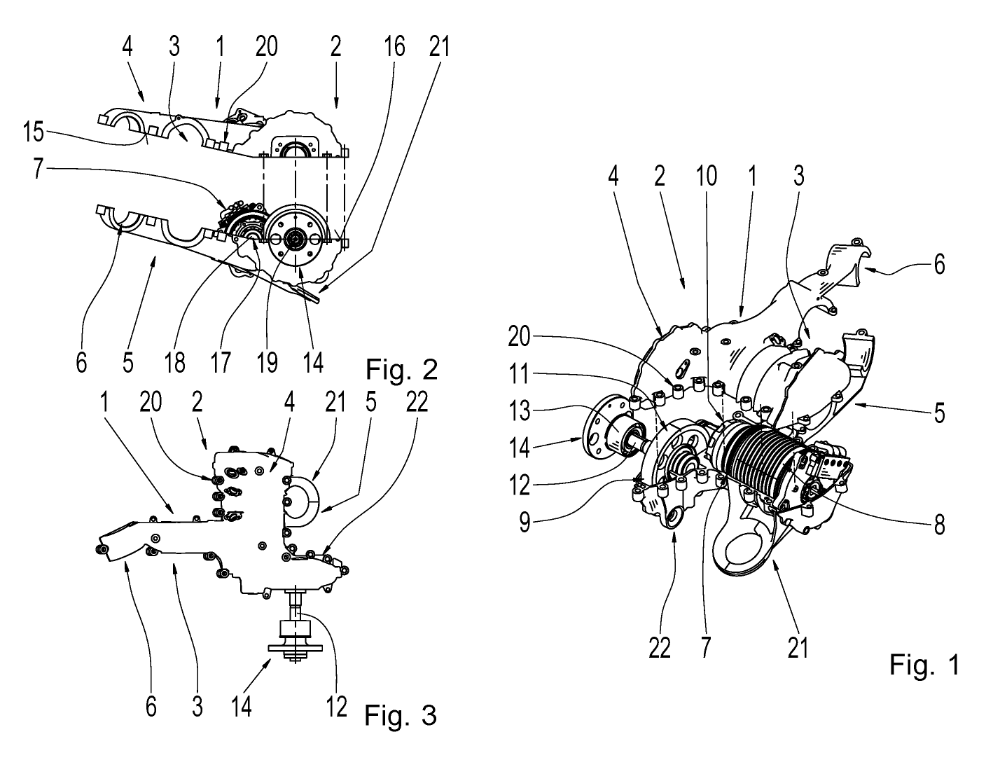

FIG. 1 shows a trailing arm 1 of a first embodiment of a drivable torsion beam axle 2, which, in a known manner, is used in a motor vehicle and which has a trailing arm 1 on each side of the vehicle. The trailing arms 1 are each connected to a transverse profiled element extending in the transverse direction of the vehicle.

Basically, the trailing arms 1 of the torsion beam axle 2 are made mirror-image identically, for which reason in the following description reference will only be made to the trailing arm 1 shown in FIG. 1.

The trailing arm 1 is in the form of a two-part housing component with a housing plane of division extending in the longitudinal direction, and in the example embodiment of the torsion beam axle 2 shown in FIG. 1 comprises, relative to a vertical axis of the vehicle and in the installed condition of the torsion beam axle in the vehicle, an upper housing component 4 and a lower housing component 5 which, as also shown in FIG. 2 and FIG. 3, besides the seat 3 for the transverse profiled element, also form a further seat 6 for a bearing device by means of which the torsion beam axle 2 can be connected to a vehicle body. Into the area of the further seat 6 there can, for example, be press-fit a bearing device made in the form of a rubber mounting which allows rotational and pivoting movements of the trailing arm 1 relative to the vehicle axle within rotational and pivoting ranges which are limited for driving safety purposes.

In the assembled condition of the drivable torsion beam axle 2, the transverse profiled element is arranged with interlock, with its end areas of polygonal shape at least on the outside, in the correspondingly polygonally shaped seats 3 of the trailing arms 1, and in that way it is connected to the trailing arms 1 in a rotationally fixed manner. Furthermore, relative movement between the transverse profiled element and the trailing arms in the transverse direction or the longitudinal direction of the transverse profiled element is prevented, for example either by press-fitting and/or bonding or welding the transverse profiled element and the trailing arms 1 to one another.

In addition the upper housing component 4 and the lower housing component 5 delimit an interior space, within which is arranged a drive-train 7, which comprises an electric machine 8 and a transmission device 9. The transmission device 9 is made with an output shaft of the electric machine 8 and a planetary gearset 10 coupled to it, and in turn a spur gear stage 11 is in functional connection therewith, which is functionally connected to a wheel axle 12. The output shaft of the electric machine 8 and the wheel axle 12 are arranged parallel to one another and when the torsion beam axle 2 is in its installed condition they are a distance apart from one another at least in the longitudinal direction of the vehicle. The wheel axle 12 is mounted by means of a wheel bearing 13 so that it can rotate in the housing components 4 and 5, and is connected to a wheel carrier 14.

The trailing arm 1 has two planes of division 15, 16 which enclose an obtuse angle α with one another. In the present case the planes of division 15 and 16 intersect in the area of the mid-point 17 of a shaft 18 of the drive-train 7, which in this case is coupled to the output shaft of the electric machine 8. Depending on the application case concerned, the planes of division 15 and 16 can also intersect in the area of the mid-point of the wheel axle 12.

The housing components 4 and 5 are connected to one another by means of a plurality of screw connections 0 to the desired extent. In addition, the housing components 4 and 5 are in functional connection with one another by virtue of centering means, preferably centering pins or the like, in order to orientate and adjust the housing components 4 and 5 relative to one another without further measures before being, with little effort, able to connect them firmly to one another by means of the screw connections 20.

In addition a spring seat 21 and a damper seat 22 are formed integrally with the lower housing component 5, such that depending on the application case concerned, the spring seat and/or the damper seat can also be connected to the lower housing component or to the upper housing component of the trailing arm 1 by bolting, bonding, riveting, welding or suchlike.

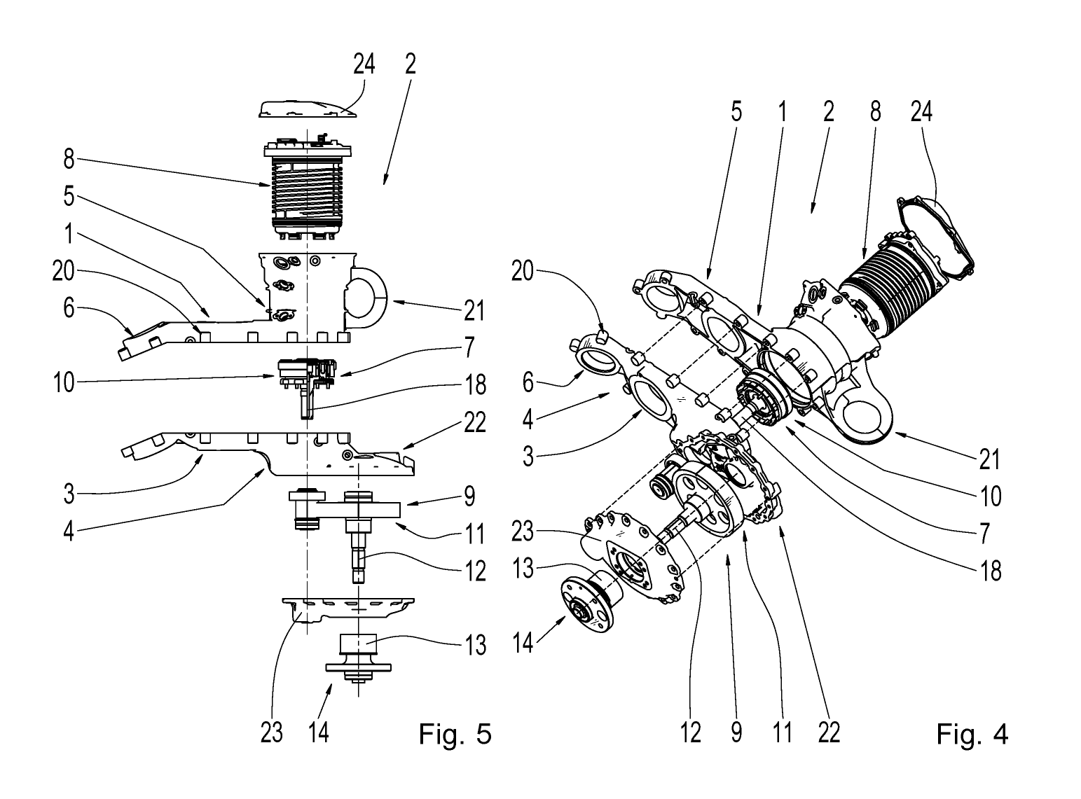

In the second example embodiment of the torsion beam axle 2 shown in FIGS. 4 and 5, the trailing arm 1 is also made with two housing halves 4, 5 and with a plane of division extending in the longitudinal direction. In the assembled position of the torsion beam axle 2 according to FIGS. 4 and 5, the housing plane of division extends essentially vertically, whereas in FIGS. 1 to 3 the housing plane of division of the trailing arm 1 of the torsion beam axle 2 in its installed condition is orientated essentially horizontally. Thus, the trailing arm 1 of the torsion beam axle 2 according to FIGS. 4 and 5 has a housing half 4 facing away from the middle of the vehicle or toward the wheel carrier 14, and a housing half 5 facing away from the wheel carrier 14, within which the drive-train 7 is arranged at least in part. On the housing halves 4 and 5, on the side facing toward the wheel carrier 14 and on the side facing away therefrom, in each case cover elements 23, 24 can be fixed by means of screw connections, which covers, in the first embodiment of the torsion beam axle according to FIGS. 1 to 3, were formed integrally with the housing halves 4 and 5.

The spring seat 21 is connected integrally to the housing half 5, whereas the damper seat 22 is made integrally with the housing half 4. Both between the housing halves 4 and 5 and also between the housing half 4 and the cover element 23 and between the housing half 5 and the other cover element 24, sealing means are in each case provided in order to seal off the interior space of the trailing arm 1 delimited by the housing halves 4 and 5 and the cover elements 23 and 24 from the surroundings.

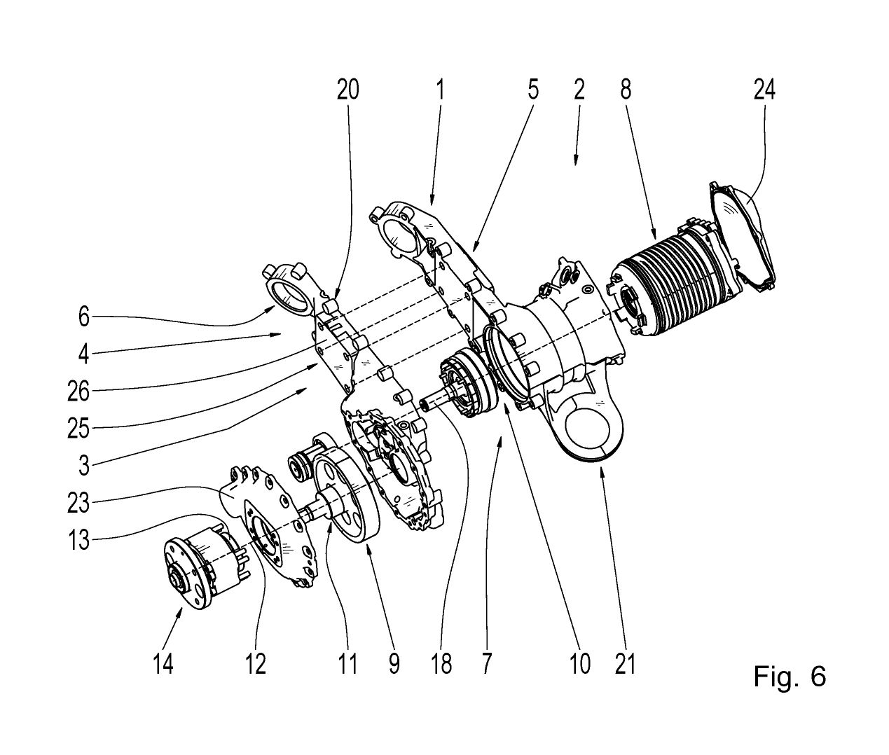

The trailing arm 1 of the third example embodiment of the drivable torsion beam axle 2 shown in FIG. 6 corresponds substantially to the trailing arm 1 of the second example embodiment of the torsion beam axle 2 according to FIG. 4. Only in the area of the seat 3 are the two trailing arms 1 made differently, for which reason in the following description of FIG. 6 essentially only the differences between the third and the second example embodiments will be described in detail, while with regard to the rest of the structure of the trailing arm 1 of the torsion beam axle 2 according to FIG. 6, reference should be made to the previous description.

In the third example embodiment of the torsion beam axle 2, in the assembled condition of the torsion beam axle 2, the transverse profiled element is positioned with flange areas at its ends in contact against flange-like areas 25 of the seats 3 of the trailing arms 1, and the transverse profiled element is firmly connected to the trailing arms 1 by means of bolts. In this case the seats 3 or their flange-like areas 25 have flat and in this case closed flange surfaces 26, against which the respective flange areas of the transverse profiled element are in contact. Thus, the closed flange surfaces 26 are on the one hand contact surfaces for the transverse profiled element and on the other hand sealing surfaces for a hollow space of the transverse profiled element made in the form of a hollow body, whereby the penetration of corrosion-promoting media such as salt water and the like in the area of the transverse profiled element into the inside of the transverse profiled element is prevented in a simple manner.

### INDEXES

1 Trailing arm
2 Torsion beam axle
3 Seat
4 Upper housing component
5 Lower housing component
6 Further seat
7 Drive-train
8 Electric machine
9 Transmission device
10 Planetary gearset
11 Spur gear stage
12 Wheel axle
13 Wheel bearing
14 Wheel carrier
15, 16 Plane of division
17 Mid-point
18 Shaft
19 Mid-point of the wheel axle
20 Bolt connection
21 Spring seat
22 Damper seat
23, 24 Cover element
25 Area
26 Flange surface

1-17. (canceled)

18. A drivable torsion beam axle (2) with a transverse profiled element and, and respective trailing arms (1) being connected to ends of the transverse profiled element,
a respective drive-train (7) being arranged, at least in part, within each of the trailing arms and being connectable to a vehicle body by way of the torsion beam axle (2), and
each of the trailing arms (1) being in a form of a two-part housing component with a housing plane of division extending in a longitudinal direction of the vehicle.

19. The drivable torsion beam axle according to claim 18, wherein the trailing arms (1), in an installed condition, have an upper housing component (4) and a lower housing component (5).

20. The drivable torsion beam axle according to claim 18, wherein the trailing arms (1), in an installed condition, have a first housing component (4) on a wheel side of the trailing arm and a second housing component (5) facing away from the wheel side of the trailing arm.

21. The drivable torsion beam axle according to claim 18, wherein the trailing arms have two planes of division (15, 16), and the two planes of division enclose with one another an obtuse angle (a).

22. The drivable torsion beam axle according to claim 20, wherein the two planes of division (15, 16) intersect in an area of a mid-point (17) of a wheel axle (12) or a shaft (18) of the drive-train (7).

23. The drivable torsion beam axle according to claim 19, wherein the upper and the lower housing components (4, 5) each form at least part of a seat (6) for a bearing device, and the torsion beam axle (2) is connectable to the vehicle body by the seat.

24. The drivable torsion beam axle according to claim 19, wherein the upper and the lower housing components (4, 5) each form at least part of a seat (3) for the transverse profiled element.

25. The drivable torsion beam axle according to claim 24, wherein the transverse profiled element is formed with end areas which are polygonally shaped at least on an outside and are arranged with interlock in the seats (3) of the trailing arms, and the seats being correspondingly polygonally shaped so that the transverse profiled element is held at least rotationally fixed to the trailing arms (1).

26. The drivable torsion beam axle according to claim 24, wherein the transverse profiled element is in contact with flange areas at ends thereof against corresponding flange-like areas of the seats (3) of the trailing arms (1) and is connected to the trailing arms (1) by bolts.

27. The drivable torsion beam axle according to claim 19, wherein interior spaces, delimited by the upper and the lower housing components (4, 5) of the trailing arms (1) and designed at least in part to accommodate the drive-train (7), are delimited on at least one of a wheel side of the trailing arms (1) and an opposite side of the trailing arms (1) facing away from wheels, in each case, by respective cover elements (23, 24) connected detachably to the housing components (4, 5).

28. The drivable torsion beam axle according to claim 18, wherein the drive-train (7) comprises at least one electric machine (8).

29. The drivable torsion beam axle according to claim 28, wherein the drive-train (7) comprises a transmission device (9) associated with the electric machine (8) and arranged between an output shaft of the electric machine (8) and the wheel axle (12).

30. The drivable torsion beam axle according to claim 29, wherein the output shaft of the electric machine (8) and the wheel axle (12) extend in an arrangement parallel to one another and, in an installed condition of the torsion beam axle (2), the output shaft of the electric machine (8) and the wheel axle are a spaced away from one another at least in the longitudinal direction of the vehicle.

31. The drivable torsion beam axle according to claim 19, wherein the upper and the lower housing components (4, 5) are connected to one another by a plurality of screw connections (20) distributed around a periphery of the upper and the lower housing components (4, 5).

32. The drivable torsion beam axle according to claim 19, wherein the upper and the lower housing components (4, 5) are connected with one another by way of a centering device.

33. The drivable torsion beam axle according to claim 18, wherein the trailing arms (1) are, on a wheel side thereof, each functionally connected to a wheel carrier (14).

34. The drivable torsion beam axle according to claim 19, wherein at least one of a spring seat and a damper seat (21, 22) is formed integrally with one of the upper and the lower housing components (4, 5).

35. A drivable torsion beam axle for coupling a transverse profiled element, the torsion beam axle comprising:
a trailing arm, and an end of the torsion beam axle being connected to the trailing arm;
at least part of a drive-train being arranged within the trailing arm, and the drive-train being connected by the torsion beam axle to a vehicle body; and
the trailing arm comprising a housing having a first housing member and a second housing member that are rigidly connectable to one another, and an interface between the first and the second housing members forming a dividing plane that extends in a longitudinal direction of the vehicle.
